(19) United States
(12) Patent Application Publication
(10) Pub. No.: US 2026/0187151 A1
(43) Pub. Date: Jul. 2, 2026

(54) EFFICIENT RESPONSE GENERATION USING REFINEMENT QUERIES AND ARTIFICIAL INTELLIGENCE

(71) Applicant: Google LLC, Mountain View, CA (US)

(72) Inventor: Wojciech W. Skut, Zurich (CH)

(21) Appl. No.: 18/859,436

(22) PCT Filed: Sep. 10, 2024
(86) PCT No.: PCT/US2024/045950

§ 371 Date: Oct. 23, 2024

Related U.S. Application Data
(60) Provisional application No. 63/591,020, filed on Oct. 17, 2023.

(51) Int. Cl. G06F 16/9032

(52) U.S. Cl. CPC G06F 16/90332

(57) ABSTRACT

Methods, systems, and apparatus, including computer programs encoded on a computer storage medium, for providing responses based on queries. In one aspect, a method includes receiving one or more first queries from a client device of a user. A determination is made that there is insufficient information based on session data including the one or more first queries to select a digital component to present to the user in response to the first query. A refinement query that has a question format and prompts the user to provide additional information related to the one or more first queries is generated based on multiple candidate refinement queries that are mapped to different entities. The refinement query is provided to the client device for presentation as a part of a first response that is generated based on at least one of the one or more first queries.

### BACKGROUND

This specification relates to data processing and artificial intelligence.

Advances in machine learning are enabling artificial intelligence to be implemented in more applications. For example, large language models have been implemented to allow for a conversational interaction with computers using natural language rather than a restricted set of prompts. This allows for a more natural interaction with the computer.

### SUMMARY

In general, one innovative aspect of the subject matter described in this specification can be embodied in methods that include the actions of receiving one or more first queries from a client device of a user; determining that there is insufficient information based on session data including the one or more first queries to select a digital component to present to the user in response to the first query; generating, based on candidate refinement queries that are mapped to different entities, a refinement query that has a question format and prompts the user to provide additional information related to the one or more first queries; providing the refinement query to the client device for presentation to the user as a part of a first response that is generated based on at least one of the one or more first queries; receiving one or more second queries from the client device of the user after having provided the refinement query to the client device for presentation to the user, wherein the second query includes a user response to the refinement query; determining that there is sufficient information in updated session data including the one or more second queries and data related to at least one of the one or more first queries to select a digital component; selecting, from multiple candidate digital components that are mapped to the different entities, a selected digital component mapped to a particular entity; and sending the selected digital component to the client device for presentation to the user as a part of a second response that is generated based on the one or more second queries. Other implementations of this aspect include corresponding apparatus, systems, and computer programs, configured to perform the aspects of the methods, encoded on computer storage devices.

These and other embodiments can each optionally include one or more of the following features. In some implementations, the one or more first queries include a search query, and wherein the first response includes search results generated by a search system based on the search query.

In some implementations, the one or more first queries include a user prompt, and the first response includes a response generated by a trained language model from processing the user prompt.

In some implementations, generating the refinement query based on the candidate refinement queries includes performing a selection process to select one or more refinement queries from the candidate refinement queries; and generating the refinement query based on the one or more selected refinement queries.

In some implementations, generating the refinement query based on the multiple candidate refinement queries includes identifying multiple candidate refinement queries to aggregate into a final refinement query based on a semantic similarity between the candidate refinements. In some implementations, the final refinement query includes a question that is semantically similar to questions included in the multiple identified candidate refinement queries. Some implementations include splitting a required amount for the final refinement query between multiple entities that provided the multiple refinement queries.

In some implementations, determining that there is insufficient information in the one or more first queries to select the digital component includes processing the one or more first queries using the trained language model to generate a sufficiency classification output.

In some implementations, generating the refinement query based on the multiple candidate refinement queries includes splitting a total amount associated with the one or more selected refinement queries among one or more entities that provided the one or more selected refinement queries.

According to a second aspect, there is provided a system including one or more computers and one or more storage devices storing instructions that when executed by the one or more computers cause the one more computers to perform operations including the operations of the first aspect.

According to a third aspect there are provided one or more computer storage media storing instructions that when executed by one or more computers cause the one more computers to perform operations including the operations of the first aspect.

According to a fourth aspect, there is provided a computer program product including instructions which, when executed by one or more computers, cause the one or more computers to perform operations including the operations of the first aspect.

Particular embodiments of the subject matter described in this specification can be implemented so as to realize one or more of the following advantages. The techniques discussed in this specification enable a service apparatus to reduce computational and network resource usage when interacting with client devices. During the interaction, the service apparatus receives queries from the client device and, in turn, provides various responses, which can include conversational answers to the queries, search results, digital components, and/or refinement queries to the client device.

Many digital components have complicated distribution criteria that are based on multiple dimensions of data. In order to select a digital component for presentation during the interaction with a client device, a selection process over a large set of candidate digital components and evaluating their presentation eligibility based on the distribution criteria may have to be repeatedly performed by the service apparatus during a conversation or search session, e.g., for each new query. Repeatedly performing this selection is computationally intensive and consumes a significant amount of computational resources especially when the set of candidate digital components is large. Moreover, many digital components have high data dimensionality (e.g., a large data size) and thus transmission of high dimensional digital components from the service apparatus to the client device may add to the burden on the network bandwidth, resulting in network latency. For example, digital component can include images, graphics, and/or videos that have larger data sizes than text. Additionally, many digital components include metadata and code, e.g., scripts, to initiate navigation to landing pages and/or reporting of data.

By incorporating information sufficiency metrics that represent an amount of information in relation to the selection and/or presentation of digital components, the described techniques reduce the amount of computational and network resources consumed by the digital components because selecting and presenting a digital component can be avoided when responding to at least some of the user queries or at least delayed until sufficient information is obtained such that the selection process and distribution of digital components may not have to be performed repeatedly. In place of the digital components that would need to be presented in response to those user queries, the service apparatus selects and presents refinement queries, which are relatively more data efficient and can be associated with simpler distribution criteria than the distribution criteria for digital components.

For example, refinement queries can be in the form of questions that are provided to a user during a conversation to obtain additional information about the user's informational needs. Such refinement queries can be in the form of text and have a smaller data size than digital components that often have images, graphics, and/or video. Using refinement queries to obtain additional information ensures that when a digital component is ultimately provided to the user, the digital component is of high quality and relevant to the user's informational needs. This reduces the computational resources required to select a digital component for each query submitted by a user and the computational resources required to send a digital component over the network and to display the digital component by the user's device. The computational savings include fewer processor cycles at the service apparatus, fewer processor cycles at the user's device, less consumed network bandwidth, and less battery use at the user's device, e.g., if the device is a battery powered mobile device. This results in more efficient devices and improved power management at the devices. In some cases, a user conversation or other form of search session may end prior to sufficient information being obtained, thereby avoiding the selection and sending of a digital component for that session, which avoids wasting such resources altogether when it is unlikely that a highly relevant digital component will be identified for the user.

Moreover, by computing information sufficiency metrics for user queries submitted to the service apparatus and using the computed metrics to determine whether to present a refinement query or a digital component during interaction with a particular user, the service apparatus ensures that presenting a digital component will not have negative consequences on the user's future engagement with the service apparatus. Accordingly, the service apparatus can use the described techniques to improve user experience and maintaining long-term user engagement.

In some implementations, the service apparatus can generate a refinement query based on candidate refinement queries received from multiple content providers. For example, the service apparatus can aggregate semantically similar candidate refinement queries into a single refinement query that is selected and provided to the client device. This can prevent or at least reduce bias introduced by independent refinement queries of individual content providers into subsequent digital component selection processes. For example, a refinement query of a content provider can be defined to target the content of the content provider, thereby creating a direct link and therefore a biased selection value for the digital component of that content provider. By aggregating refinement queries over multiple content providers, the subsequent selection values of the content providers for their digital components are real and unbiased by the refinement query presented to the user. In other words, the selection values are not skewed due to an independent refinement query of a single content provider being shown to the user prior to the digital component selection process. This provides a fair selection process and ensures that relevant content is provided to the user rather than content that is biased due to previous refinement queries presented to the user.

Using artificial intelligence to determine when to provide refinement queries and/or to select digital components when appropriate to do so is a specific use of AI to solve problems arising from insufficient information for selection processes in conversational user interfaces. For example, the described techniques of using information sufficiency metrics to determine when there is sufficient information to trigger a digital component selection process or to instead select a refinement query delays or prevents computationally intensive digital component selections processed from being performed in the absence of sufficient information to select a high quality digital component.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which responses are provided based on queries.

FIG. 2 is a flow chart of an example process for selecting refinement queries and digital components.

FIG. 3 is an example illustration of interactions between a service apparatus and a client device.

FIG. 4 a block diagram of an example computer.

Like reference numbers and designations in the various drawings indicate like elements.

### DETAILED DESCRIPTION

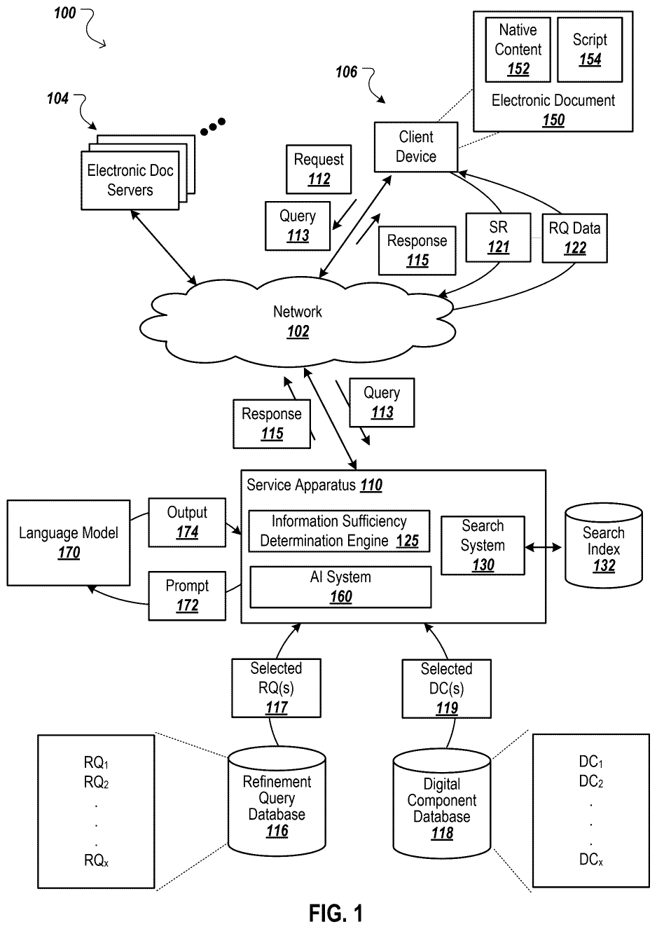

FIG. 1 is a block diagram of an example environment 100 in which responses are provided based on queries. The responses can include conversational answers to the queries, search results, digital components, and/or refinement queries.

In general, a refinement query has a question or request format and cues a user to provide additional information, e.g., in a subsequent query, that facilitates later selection of digital components for presentation to the user. The queries can be provided at a search page of a search engine or at a conversational user interface of an AI chatbot and the responses can be provided in a search results page or at the conversational user interface.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

The example environment 100 includes a network 102, such as a local area network (LAN), a wide area network (WAN), the Internet, or a combination thereof. The network 102 connects electronic document servers 104, client devices 106, and a service apparatus 110. The example environment 100 may include many different electronic document servers 104 and client devices 106.

A client device 106 is an electronic device capable of requesting and receiving online resources over the network 102. Example client devices 106 include personal computers, gaming devices, mobile communication devices, digital assistant devices, wearable devices (e.g., smart watches), augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection).

Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106. Examples of electronic documents include the outputs of a language model, web pages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include app servers from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents, which can also be referred to as electronic resources or resources, can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) includes a script (e.g., script 154) that references the service apparatus 110, or a particular service provided by the service apparatus 110. In these situations, the script is executed by the client device 106 when the given electronic document is processed by the client device 106. Execution of the script configures the client device 106 to generate a request for digital components 112 (referred to as a “component request”), which is transmitted over the network 102 to the service apparatus 110. For example, the script can enable the client device 106 to generate a component request 112 that is packetized and includes a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, e.g., the selected digital components 119 or other digital components from the database 116, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., Uniform Resource Locator (URL)) to an electronic document (e.g., a webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, and a type of device at which the digital component will be displayed, such as a mobile device or tablet device). Component requests 112 can be transmitted, for example, over a packetized network.

To facilitate searching of electronic documents, the service apparatus 110 includes a search system 130 that can identify the electronic documents by crawling and indexing the electronic documents (e.g., indexed based on the crawled content of the electronic documents). Although illustrated in FIG. 1 as being implemented as part of the service apparatus 110, in some implementations, the search system 130 can be physically remote from other components of the service apparatus 110, but the search system 130 can be communicatively coupled to the service apparatus 110, e.g., via the network 102. Data about the electronic documents can be indexed based on the electronic document with which the data are associated. The indexed and, optionally, cached copies of the electronic documents are stored in a search index 132 (e.g., hardware memory device(s)). Data that is associated with an electronic document is data that represents content included in the electronic document and/or metadata for the electronic document.

Client devices 106 can submit queries 113 to the service apparatus over the network 102. In response, the search system 130 accesses the search index 132 to identify electronic documents that are relevant to the query. The search system 130 identifies the electronic documents in the form of search results and returns responses 115, which include the search results in search results pages, to the client device 106. A search result is data generated by the search system 130 that identifies an electronic document that is responsive (e.g., relevant) to a particular search query, and includes an active link (e.g., hypertext link) that causes a client device to request data from a specified location in response to user interaction with the search result.

An example search result can include a web page title, a snippet of text or a portion of an image extracted from the web page, and the URL of the web page. Another example search result can include a title of a downloadable application, a snippet of text describing the downloadable application, an image depicting a user interface of the downloadable application, and/or a URL to a location from which the application can be downloaded to the client device 106. Another example search result can include a title of streaming media, a snippet of text describing the streaming media, an image depicting contents of the streaming media, and/or a URL to a location from which the streaming media can be downloaded to the client device 106. Like other electronic documents, search results pages can include one or more slots in which digital components (e.g., third-party content, such as video files, audio files, images, text, gaming content, augmented reality content, and combinations thereof, which can all take the form of advertising content or non-advertising content) can be presented.

Client devices 106 can also submit queries for users via a conversational user interface, e.g., an interface of an AI chatbot. In such implementations, the search system 130 can return responses to queries that may not be in the form of a search result. For example, the response may be in the form of a natural language answer or follow up question.

The service apparatus 110 also includes an artificial intelligence (AI) system 160 that implements one or more language model neural networks 170, also referred to simply as “language models,” which can include large language models. A large language model (“LLM”) is a model that is trained to generate and understand human language and/or computer code. LLMs are trained on massive datasets of text and/or code, and they can be used for a variety of tasks. For example, LLMs can be trained to translate text from one language to another; summarize text, such as web site content, search results, news articles, or research papers; answer questions about text, such as “What is the capital of Georgia?”; create chat bots that can have conversations with humans; and generate creative text, such as poems and stories (in a natural language) and computer code (in a programming language).

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) multiple attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J.W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI system 160) causes the language model 170 to generate output sequences according to pre-determined syntax through natural language prompts in the input sequence.

For example, the service apparatus 110 (e.g., AI system 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

The language model 170 can be configured through training to perform any kind of language modeling tasks, i.e., can be configured to receive any kind of input prompt 172, also referred to simply as “prompt,” and to generate any kind of output sequences 174, also referred to simply as “output,” based on the prompt 172. Typically, the AI system 160 receives a prompt 172 that is submitted to the language model 170, and causes the language model 170 to generate the output 174 that is a response to the prompt 172. The output 174 is then provided as a response 115 to the client device 106, e.g., for presentation to a user.

As one example, the language model 170 can be configured to perform a text generation task. In this example, the service apparatus 110 receives one or more queries 113 from the client device 106 and then uses the one or more received queries 113, and possibly other information included in a user session, to generate a prompt 172, e.g., based on a concatenation of the one or more received queries 113. For example, the one or more queries 113 can include queries submitted by the client device 106 to the search system 130, or other queries submitted as part of, or associated with, separate requests for an output 174 by the AI system 160. The service apparatus provides the prompt 172, which generally includes a sequence of text, to the AI system 160.

In turn, the AI system 160 submits the received prompt 172 to the language model 170, which processes the prompt 172 to generate the output 174 that is another sequence of text, e.g., a completion of the sequence of text included in the prompt 172, a response to a question posed in the sequence of text included in the prompt 172, or a sequence of text that is about a topic specified by the sequence of text included in the prompt 172. The service apparatus 110 then provides the output 174 as a response 115 to the client device 106 for presentation to the user, e.g., either as part of, or in addition to, the search results that have been generated by the search system 130 based on the query 113, e.g., in a search results page, or as a separate response to the separate request, e.g., at a conversational user interface.

The service apparatus 110 includes an information sufficiency determination engine 125 that determines whether to perform one or more actions with respect to the prompt 172. The actions can include selecting and presenting one or more digital components, e.g., together with or separate from the output 174, to the client device 106. The actions can include generating one or more refinement queries that cue (or prompt) the user to provide additional information, e.g., by way of submitting additional queries (which can be in the form of user prompts) to the service apparatus 110. For example, the service apparatus 110 can make this determination by using the information sufficiency determination engine 125 in parallel with using the language model 170 to generate the output 174 from the prompt 172 or after having used the language model 170 to generate the output 174 (but before transmitting it to the client device 106).

In some implementations, the information sufficiency determination engine 125 computes an information sufficiency metric for the prompt 172 and determines whether to perform the one or more actions based on the information sufficiency metric. For example, the information sufficiency determination engine 125 can determine whether to perform the one or more actions by comparing the information sufficiency metric against a set of information sufficiency metric thresholds. The information sufficiency metric can be any metric that represents an amount of information contained in the prompt 172 in relation to the selection and/or presentation of digital components (e.g., third-party content, such as video files, audio files, images, text, gaming content, augmented reality content, and combinations thereof). For example, the information sufficiency metric can take the form of numeric values (e.g., a value between 0 and 1, between 1 and 10, and so on). As another example, the information sufficiency metric can take the form of a selection of one discrete label output multiple discrete labels (e.g., “unavailable,” “available but insufficient,” “sufficient,” and so on).

Any of a variety of ways can be used to generate the information sufficiency metric. For example, the information sufficiency determination engine 125 can generate the information sufficiency metric by analyzing the prompt 172 using appropriate text processing logic, e.g., text extraction and/or analysis logic. Keyword extraction logic can, for example, be used to identify and extract one or more keywords from the prompt 172, which are then compared against a predetermined list of keywords associated with the candidate digital components. A keyword can be a unigram, i.e., consisting of a single word, or a multi-gram, i.e., consisting of multiple words. In a broader sense, a keyword can also include any string that consists of a sequence of characters, which may or may not have literal or practical meaning. In this example, the information sufficiency metric can then be computed, e.g., based on a total number, percentage, or both of the keywords in the predetermined list that match with the extracted keywords.

As another example, the information sufficiency determination engine 125 can generate the information sufficiency metric by making use of the AI system 160-and the AI system 160 uses a language model 170 (or other machine learning model) to process the prompt 172 to generate a sufficiency classification output that defines the information sufficiency metric for the prompt. In this example, the language model 170 that is used to evaluate the prompt 172 may, but need not, be the same language model that is used to generate the output 174 from the prompt 172. For example, one language model, which is specially trained to predict information sufficiency metrics of text input in relation to digital components, may be invoked by the information sufficiency determination engine 125 to compute the information sufficiency metric for the prompt 172, while another model that is broadly trained on text generation tasks may be invoked by the AI system 160 to generate the output 174 in response to the prompt 172. As the prompt 172 can include a currently and optionally previous queries submitted by the user, the information sufficiency metric can be based on one or more queries.

In some implementations, the set of information sufficiency metric thresholds include a first threshold and a second threshold that are different from each other. The first threshold may be referred to as a “refinement query threshold,” while the second threshold may be referred to as a “digital component threshold.” In general, having more than one threshold level may provide a more accurate determination of the actions that should be taken. It has therefore been contemplated that the set of information sufficiency metric thresholds can include more than two threshold levels that are either similar to or different from each other.

For example, the refinement query threshold can define a first numeric value that is lower than a second numeric value defined by the digital component threshold, where lower numeric values generally indicate less available information in relation to digital components than higher numeric values. In this example, if the computed information sufficiency metric for the prompt 172 has a computed numeric value that is lower than the first numeric value (and, thus, does not satisfy the refinement query threshold), then the service apparatus 110 can make the determination to withhold presenting any digital components.

If the computed information sufficiency metric for the prompt 172 has a computed numeric value that is higher than the first numeric value (and, thus satisfies the refinement query threshold) but lower than the second numeric value (and, thus does not satisfy the digital component threshold), then the service apparatus 110 can make the determination to select and present one or more refinement queries while still withholding the presentation of any digital components. Each refinement query cues the user to provide additional information, e.g., by way of submitting additional prompts 172 to the service apparatus 110, that will facilitate later selection of the digital components.

If the computed information sufficiency metric for the prompt 172 has a computed numeric value that is higher than both the first and the second numeric values (and thus satisfies both refinement query threshold and digital component threshold), then the service apparatus 110 can make the determination to select and present one or more digital components on the client device 106. Each digital component when viewed by the user will generally complement the search results and/or outputs 174 to satisfy their informational needs.

By making use of the information sufficiency metrics computed by the information sufficiency determination engine 125, the service apparatus 110 ensures that presenting a digital component to a user in response to a prompt 172 submitted by the user will not have negative consequences on the user's future engagement with the service apparatus 110, e.g., will not reduce the total number of subsequent queries that would be submitted by the user to the service apparatus 110, or the total number of subsequent search queries that would be submitted by the user to the search system 130.

For example, assuming that a digital component is delivered for presentation as a response 115 on the client device 106 together with an output 174 to every response 113 submitted by the user, it is likely that a topic that the digital component relates to is irrelevant or undesirable to the present conversation turns between the user and the language model 170. As a result, a user's experience with the service apparatus 110 is negatively impacted. In fact, selecting irrelevant or undesirable digital component can result in a failed delivery of the subsequent digital components. For example, if an ongoing conversation at the client device 106 is terminated early by the user due to the presentation of irrelevant or undesirable digital components along with an output 174 to an earlier query, then no future digital components can be presented.

By incorporating a set of information sufficiency metrics that represents an amount of information in relation to the selection and/or presentation of digital components, the described techniques reduce the amount of computational and network resources consumed by the digital components because selecting and presenting a digital component can be avoided when responding to at least some of the user queries or at least delayed until sufficient information is obtained such that the selection process and distribution of digital components does not have to be performed repeatedly.

In some implementations, the service apparatus 110 is implemented in a distributed computing system that includes, for example, a server and a set of multiple computing devices that can operate together to execute the operations of the information sufficiency determination engine 125 and the AI system 160, including the language model 170. The set of multiple computing devices can also operate together to use the techniques described below to determine whether, and if so, which digital components to be presented.

As illustrated in FIG. 1, the service apparatus 110 includes or has access to a refinement query database 116 and a digital component database 118. The refinement query database 116 stores a corpus of multiple candidate refinement queries RQ₁₋ₓ which are received from content platforms (e.g., third-party content providers) and additional data (e.g., metadata) for each candidate refinement query. As used herein, the term “refinement query” refers to a query automatically generated from one or more of the candidate refinement queries RQ₁₋ₓ that can be used to learn more information about the user who input the one or more queries 113 (which are used to generate the prompt 172). As mentioned above, the one or more queries 113 can include a query submitted by the client device 106 to the search system 130, and/or another query submitted as part of, or associated with, a separate request for an output 174 by the AI system 160.

These candidate refinement queries RQ₁₋ₓ can take many different forms that cue the user for additional information. In some implementations, a candidate refinement query can include a statement as to why the prompt 172 is considered to be insufficient. Candidate refinement queries can also include a call to action that identifies one or more actions for the user to complete, e.g., answering a question, completing a survey, or some other action. For example, a candidate refinement query can include language along the lines of, “We could not find a digital component this time. Do you want to participate in a survey?” In this example, upon user participation in the survey (e.g., after selecting a control), survey questions can be presented that are based on limited information that may be known about the user, the user's location, the electronic document 150 that is requested, and/or other signals, in order to learn more information about the user.

In some implementations, a candidate refinement query can include a follow-up question. The follow-up question can be specific, such as a question about a specific entity (e.g., “Do you care about products from entity A?”). Alternatively, the follow-up question can be generic, such as a question about the user preferences (e.g., “What are your hobbies?”). In either example, the follow-up question can be used to learn more information about the user.

The metadata for a candidate refinement query can include, for example, distribution criteria that defines the situations in which the candidate refinement query is eligible to be provided to a client device 106 in response to a prompt 172 received from the client device 106. The service apparatus 110 can access the refinement query database 116 to identify distribution criteria associated with a given refinement query. Thus, in some implementations, if the computed information sufficiency metric for a prompt 172 satisfies the refinement query threshold, then the refinement queries that are provided in response to prompt 172 are selected based at least in part on distribution criteria associated with the candidate refinement queries.

Alternatively, in other implementations, no distribution criteria need to be stored (either as metadata or in any other format), and service apparatus 110 can send the prompt 172 in real-time to a number of entities (e.g., third party content providers) and in response, receive the one or more refinement queries that are provided by one or more of these entities to be used for presentation.

In the former implementations (where the distribution criteria are stored as metadata for candidate refinement queries), the service apparatus 110 can generally select, as selected refinement queries for presentation on the client device 106, any number of candidate refinement queries from the refinement query database 116 that satisfy the distribution criteria.

For example, the distribution criteria for a candidate refinement query can include distribution keywords that must be matched (e.g., by resource keywords or search queries) in order for the refinement query to be eligible for presentation.

As another example, the distribution criteria can specify a selection value and/or a total distribution amount for distributing a candidate refinement query. A selection value can represent an amount that an entity (e.g., third party content provider) is willing to provide in response to the refinement query being presented to the user. A total distribution amount can represent an amount that the entity is willing to provide over a specified time period for the refinement query to be presented to users. In some implementations, selection values can be used in a selection process to select which refinement query will be presented and/or in which slot the refinement query will be presented. A third-party content provider of the candidate refinement query can specify the total distribution amount, which will limit the maximum amount that the content provider will spend over a specified period. The content provider can also specify a maximum amount to pay for a particular presentation of a refinement query.

As another example, the distribution criteria for a candidate refinement query can include location information indicating which geographic locations that candidate refinement query is eligible to be presented, and/or other appropriate distribution criteria.

As yet another example, the distribution criteria can include negative criteria, e.g., criteria indicating situations in which the candidate refinement query is not eligible (e.g., with particular resources or in particular locations). Other data that can be used to select a candidate refinement query can also be stored in the refinement query repository 116 with a reference (e.g., a link or as metadata) to its candidate refinement query.

The digital component database 118 stores a corpus of multiple candidate digital components DC₁₋ₓ which have been made available for distribution and additional data (e.g., metadata) for each digital component. In some situations, the digital component database 118 can receive the candidate digital components from the same content platforms (e.g., third-party content providers) that also provided the candidate refinement queries RQ₁₋ₓ.

Like the metadata for candidate refinement queries, the metadata for a candidate digital component can include, for example, distribution criteria, e.g., distribution parameters, that define the situations in which the digital component is eligible to be provided to a client device 106 in response to a prompt 172 received from the client device 106. The service apparatus 110 can access the digital component database 118 to identify distribution criteria associated with a given digital component. Thus, if the computed information sufficiency metric for a prompt 172 satisfy both the refinement query threshold and the digital component threshold, then the digital components that are provided in response to a query from the client device 106 are selected based at least in part on distribution criteria associated with the candidate digital components. Generally, the service apparatus 110 can select, as selected digital components 119 for presentation on the client device 106, any number of candidate digital components from the digital component database 118 that satisfy the distribution criteria.

In some implementations, the service apparatus 110 selects, as selected digital components 119, candidate digital components that are associated with a single entity, e.g., a single third-party content provider or another content source. That is, if the computed information sufficiency metric for a prompt 172 satisfies both the refinement query threshold and the digital component threshold, then a set of one or more selected digital components 119 that have all been provided by the same third-party content provider will be selected.

Unlike the digital components, however, the service apparatus 110 can typically select, as selected refinement queries 117, candidate refinement queries that are associated with multiple entities, e.g., different third-party content providers or other content sources.

That is, if the computed information sufficiency metric for a prompt 172 satisfies the refinement query threshold (but not the digital component threshold), then a set of one or more selected refinement queries 117 that have been respectively provided two or more third-party content providers that are different from each other will be selected.

In some implementations, the required amount of resources (e.g., computational resource or other resource) associated with the selection and presentation of the selected refinement queries 117 can thus be split among those different entities, thereby lowering the amount of resource that would be required in order for each individual entity to present the refinement queries 117.

In some implementations, the service apparatus 110 can aggregate candidate refinement queries into a single candidate refinement query. For example, the service apparatus 110 can identify a set of candidate refinement queries that are semantically similar to one another and aggregate the semantically similar candidate refinement queries into a single candidate refinement query. As an example, one content provide may provide a candidate refinement query of “are you interested in baseball” and another content provider may provide a candidate refinement query of “are you a baseball fan,” and yet another content provider may provide a candidate refinement query of “do you play baseball.” Here, all of the refinement queries are related to baseball and the service apparatus 110 can aggregate these refinement queries into an aggregate refinement query of “do you like or participate in baseball?”

The service apparatus 110 can also aggregate the selection values for the refinement queries that are aggregated. For example, the service apparatus 110 can generate an aggregate selection value that is the sum of the selection values of the refinement queries that are aggregated to generate the aggregate refinement query. If the refinement query is selected for presentation to the user, the total cost of presenting the aggregate refinement query (e.g., a required amount that is required to be provided to an entity that operates the service apparatus 110) can be split between the content providers that provided the refinement queries that were aggregated into the aggregate refinement query. Aggregating refinement queries in this way can reduce bias of individual refinement queries that would lead the service apparatus 110 to select digital components of the content provider whose refinement query was selected and presented to the user.

The service apparatus 110 can generate and transmit, over the network 102, response data (e.g., digital data representing a response 115) that enable the client device 106 to integrate the set of selected refinement queries 117 (and, analogously, the set of selected digital components 119) into a given electronic document, such that the set of selected refinement queries 117 are presented at a display of the client device 106. For example, the set of selected refinement queries 117 can be presented together with a response 115 that also includes: (i) the output 174 generated by the language model 170, (ii) the search results page, (iii) the native content 152 of the electronic document, or some combination thereof.

In some implementations, the client device 106 executes instructions included in the response data, which configures and enables the client device 106 to use the set of selected refinement queries 117 to generate the final refinement query that will be presented to the user. For example, when each refinement query has a question format, the instructions in the response data can define data generation logic that causes the client device 106 to generate a question that is semantically similar to multiple questions included in the selected refinement queries 117. As another example, the instructions in the response data can define data aggregation logic that causes the client device 106 to aggregate and display, e.g., in the format of a bullet point list or a summary, the set of selected refinement queries 117 provided by different content providers.

In some implementations, the client device 106 executes instructions included in the response data, which configures and enables the client device 106 to obtain the set of selected refinement queries 117 from the refinement query database 116. Analogously, in some implementations, the client device 106 executes instructions included in the response data, which configures and enables the client device 106 to obtain the set of selected digital components 119 from the digital component database 118.

For example, the instructions in the response data can include a network location (e.g., a URL) and a script that causes the client device 106 to transmit a server request (SR) 121 to the refinement query database 116 to obtain a given selected refinement query from the refinement query database 116. In response to the request, the refinement query database 116 will identify the given selected refinement query specified in the server request 121 (e.g., within the refinement query database 116 storing multiple candidate refinement queries) and transmit, to the client device 106, refinement query data (RQ Data) 122 that presents the given selected refinement queries at the client device 106.

When the client device 106 receives the response data, the client device will present the response 115 represented by the response data at an appropriate location. For example, the selected refinement queries 117 (and, analogously, the set of selected digital components 119) can be presented, e.g., along with or in place of the search results, in a search results page. As another example, the selected refinement queries 117 (or, analogously, the set of selected digital components 119) can be presented, e.g., along with or in place of an output 174, in a conversational user interface.

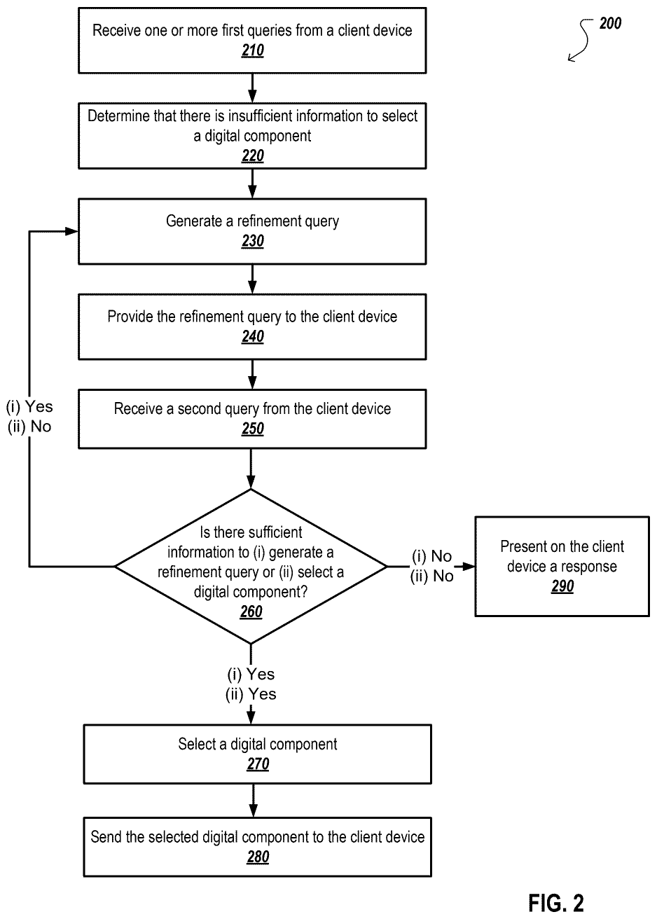

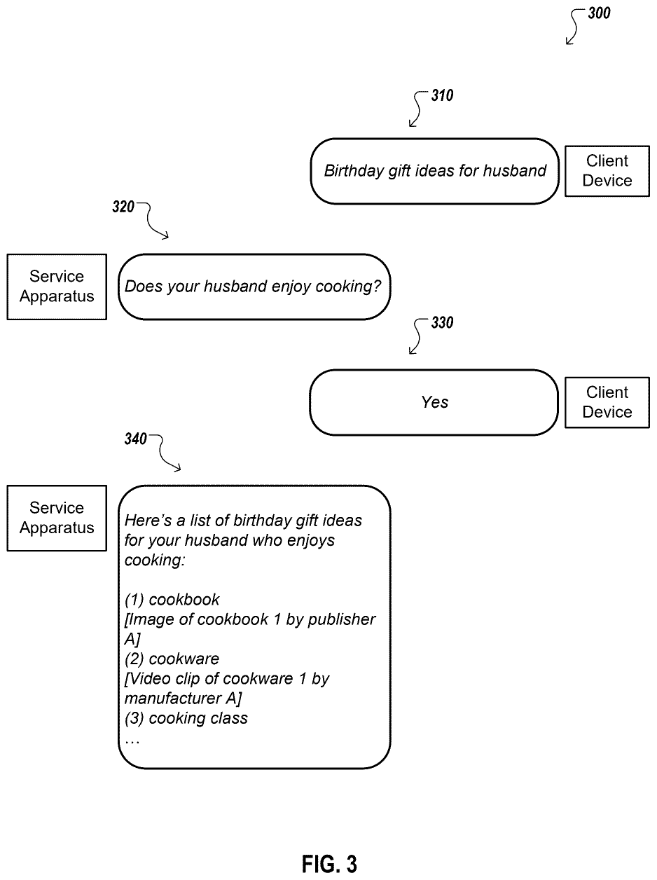

FIG. 2 is a flow chart of an example process 200 for selecting refinement queries and digital components. Operations of the process 200 can be performed, for example, by the service apparatus 110 of FIG. 1, or another data processing apparatus. The operations of the process 200 can also be implemented as instructions stored on a computer readable medium, which can be non-transitory. Execution of the instructions, by one or more data processing apparatus, causes the one or more data processing apparatus to perform operations of the process 200. The example process 300 is described with reference to FIG. 3, which is an example illustration 300 of interactions between a service apparatus and a client device.

The service apparatus receives one or more first queries from a client device of a user (step 210). The one or more first queries can be received in any of a variety of ways. For example, with reference to FIG. 1, the first query can be a query submitted by the client device 106 to the search system 130, or can alternatively be a query submitted as part of, or associated with, a request submitted by the client device 106 to the AI system 160 for an output 174. The client device includes one or more input devices that can receive a query as text-based input (e.g., a query typed using a keyboard), selection-based input (e.g., touchscreen selection, etc.), and audio-based input (e.g., voice input). In the example of FIG. 3, the first query 310 is “Birthday gift ideas for husband”.

The service apparatus includes an artificial intelligence (AI) system that implements one or more language models. In some situations, the service apparatus and the client device can, respectively, be the same or similar to the service apparatus 110 and client device 106 of FIG. 1.

The service apparatus determines whether there is sufficient information to select a digital component from multiple candidate digital components (step 220). The service apparatus can make this determination based on session data that includes the one or more first queries. The session data is generated as a result of the interaction between the client device and the service apparatus.

In some implementations, the session data includes contextual data that characterizes the current round of interaction (namely, the one or more first queries). In other implementations, the session data also includes contextual data that characterizes any past rounds of interaction, e.g., in addition to just the one or more first queries. For the current round of interaction, the contextual data can include the one or more first queries. For the past interaction, the contextual data can include the one or more previous queries (submitted by the client device in one or more previous rounds of interaction), one or more previous search results responsive to the queries, and, in some cases, metadata associated with the previous queries and/or the search results.

In some implementations, the session data includes data related to a current user session with a search system. For example, the session data can include the queries submitted during a conversation with an AI chatbot and contextual data related to the conversation. The contextual data of the session data can include, for example, the location of the client device from which the queries are received, data indicating results provided in response to the queries, the spoken language in which the queries are submitted, and/or other contextual data.

A user session can be defined by a start event and an end event. The start event can be the opening or launching of the search interface at the client device or receipt of a first query from the client device. For example, the start event can be when the user navigates to a search interface provided in a web page or the opening of a native application that includes the search interface. The end event can be the closing of the search interface or a navigation from the web page that includes the search interface. The end event can also be based on a duration of time since a last query has been received. For example, the service apparatus can determine that a user session has ended if no queries are received from the client device for at least a threshold period of time, e.g., five minutes, ten minutes, one hour, or another time period.

In some implementations, the service apparatus computes an information sufficiency metric for the session data and then compares the information sufficiency metric against one or more information sufficiency metric thresholds to determine whether there is sufficient information to select a digital component. The information sufficiency metric can be any metric that represents an amount of information contained in the session data in relation to the selection and/or presentation of digital components. The information sufficiency metric can be computed, for example, by analyzing the session data using appropriate text processing logic, or evaluating the session data using a trained language model.

In some implementations, the set of information sufficiency metric thresholds include a refinement query threshold and a digital component threshold that are different from each other. For example, the refinement query threshold can define a first numeric value that is lower than a second numeric value defined by the digital component threshold, where lower numeric values generally indicate a lack of available information in relation to digital components. Thus, if the computed information sufficiency metric is higher than the first numeric value, and, thus, meets the refinement query threshold, but lower than the second numeric value, and, thus, fails to meet the digital component threshold, then the service apparatus can determine that there is insufficient information contained in the session data in order to facilitate the selection and/or presentation of any digital components (although there is sufficient information to generate a refinement query).

In response to determining that there is insufficient information contained in the session data, the process 200 proceeds to step 230, where the service apparatus generates, based on multiple candidate refinement queries, a refinement query (step 230). In particular, because the computed information sufficiency metric for the session data has a computed numeric value that is lower than the first numeric value (and, thus, does not satisfy the refinement query threshold), then the service apparatus decides to withhold presenting any digital components to the user.

The refinement query has a question format and cues the user to provide additional information related to the one or more first queries. As illustrated in FIG. 3, the service apparatus thus presents to the client device a refinement query 320:“Does your husband enjoy cooking?” Also, no digital component is selected for presentation on the client device to the user who submitted the one or more first queries.

Generating the refinement query can involve performing a selection process to select one or more refinement queries from a refinement query database, and then generating the refinement query based on the one or more selected refinement queries. The refinement query database stores multiple candidate refinement queries that are provided by multiple entities, e.g., different third-party content providers.

For example, the one or more refinement queries are selected based at least in part on distribution criteria associated with the candidate refinement queries. As described above, the distribution criteria can be stored in the refinement query database as metadata associated with the candidate refinement queries.

Other approaches to select the one or more refinement queries are possible. For example, the service apparatus selects a refinement query based on a category or topic that is likely to receive user input. A refinement query can, for example, be selected on the category or topic of the session data. As another example, a refinement query can be selected without regard for information contained in the session data. Instead, the service apparatus can select a refinement query that is not based on any of the information contained in the session data. The refinement query can, for example, be a random question designed so that user-provided answers can be used to learn additional information about the user. As yet another example, multiple refinement queries can be selected based on a semantic similarity between them.

In particular, in any of these examples, the service apparatus can select one or more refinement queries that have been provided by multiple different particular entities, e.g., two or more third-party content providers that are independent from each other. When one refinement query is being selected, the service apparatus can use the selected refinement query as the final refinement query to be presented to the user.

When more than one refinement query is being selected, the service apparatus can compile the selected refinement queries into a collection that includes information taken from the multiple refinement queries, and then use the collection as the final refinement query to be presented to the user. For example, the collection can be in the form of bullet point list of clauses, where each clause corresponds to a refinement query. As another example, the collection can be in the form of a summary, e.g., a paragraph summary. The summary can be generated, for example, by using a language model that has been trained to perform summarization tasks to process the multiple refinement queries.

The service apparatus provides the refinement query to the client device for presentation on a display of the client device to the user (step 240). In the example of FIG. 3, the refinement query 320 (“Does your husband enjoy cooking?”) is provided for presentation to the user as a first response generated by the service apparatus based at least on the one or more first queries. In other examples, the refinement query 320 can be provided for presentation together with (or, in addition to) a first response to the one or more first queries. When the one or more first queries are received as search queries, for example, the first response can include search results generated by the search system based on the search queries. When the one or more first queries are received as prompts, for example, the first response can include response text generated by a trained language model included in the AI system from processing the prompt.

The service apparatus receives one or more second queries from the client device of the user after having provided the refinement query to the client device for presentation to the user (step 250). The second queries include a user response to the refinement query. As illustrated in FIG. 3, the client device submits a second query 330:“Yes”. For example, a user can view the refinement query on the display of the client device, and subsequently enter their response to the refinement query as a text-based input, a selection-based input, or an audio-based input.

The service apparatus determines whether there is sufficient information in updated sessions data that includes the one or more second queries (step 260). The updated session data includes contextual data that characterizes the current round of interaction (namely, the one or more second queries) and, in some implementations, contextual data that characterizes any past rounds of interaction (e.g., at least one of: the one or more first queries submitted by the client device, or the refinement query generated by the service apparatus). To make this determination, the service apparatus computes an information sufficiency metric for the updated session data and then compares the information sufficiency metric against the set of information sufficiency metric thresholds.

Continuing with the example above where the refinement query threshold defines a first numeric value that is lower than a second numeric value defined by the digital component threshold, if the computed information sufficiency metric is lower than both the first and second numeric values, and, thus, fails to meet both the refinement query threshold and digital component threshold, then the process 200 branches to step 290. That is, the service apparatus determines that the information contained in the updated session data is not only insufficient to facilitate the selection and/or presentation of any digital components, but is in fact also insufficient to facilitate the generation of any refinement queries. Accordingly, at step 290, the service apparatus presents on the display of the client device to the user only a response that is generated based on the one or more second queries. For example, the response can include search results generated by the search system. As another example, the response can include a response generated by the AI system.

Alternatively, if the computed information sufficiency metric is higher than the first numeric value, but is lower than the second numeric value, then the process 200 returns to step 230. That is, the service apparatus determines that the information contained in the updated session data is still insufficient to facilitate the selection and/or presentation of any digital components, but is sufficient to facilitate the generation of a refinement query. Accordingly, the service apparatus returns to step 230 to generate another refinement query that has a question format and cues the user to provide further additional information related to the one or more second queries.

Further alternatively, if the computed information sufficiency metric is higher than both the first numeric value and the second numeric value, the process 300 proceeds to step 270. That is, the service apparatus determines that the information contained in the updated session data is sufficient to facilitate the selection and/or presentation of a digital component. Accordingly, the service apparatus selects and presents a digital component on the display of the client device.

The service apparatus selects one or more digital components from a digital component database based on the updated session data that includes the one or more second queries (step 270). The digital component database stores multiple candidate digital components that are provided by multiple entities, e.g., different third-party content providers, which can in some situations be the same entities that also provided the candidate refinement queries. In some implementations, the one or more digital components are selected based at least in part on distribution criteria associated with the candidate digital components.

Unlike the refinement queries, however, the service apparatus specifically selects digital components that have been provided by a same particular entity, e.g., a same third-party content provider. For example, the particular entity can be one of the entities who also provided the refinement queries that were selected at step 230.

The service apparatus sends the selected digital component to the client device for presentation on the display of the client device to the user as a part of a second response that is generated based on the updated session data that includes the one or more second queries (step 280). For example, the second response can include search results generated by the search system. As another example, the second response can include a response generated by the AI system.

In the example of FIG. 3, a second response 340 is provided for presentation to the user. The response 340 is generated by the service apparatus based on the updated session data, e.g., by a trained language model included in the service apparatus from processing an input that includes the second query 330 and, in some implementations, the first query 310 and the refinement query 320. The response 340 includes a bullet point list:
“Here's a list of Birthday gift ideas for your husband who enjoys cooking:
   (i) cookbook
   (ii) cookware
   (iii) cooking class
   . . . ”

In particular, as illustrated, the service apparatus presents two digital components along with the response 340. A first digital component is an image of a particular cookbook published by publisher A. A second digital component is a video of a particular cookware made by manufacturer A. Both publisher A and manufacturer A are among the entities that provided the candidate refinement queries and the candidate digital components to the service apparatus.

One of the advantages to presenting digital components only after both the information sufficiency metric thresholds have been met is that, the service apparatus can ensure a user's experience with the service apparatus will not be negatively impacted by the digital components. The digital components are selected and presented only when a user's intent becomes clear. The refinement queries that are selected and presented prior to the digital components enable collection of additional information that helps the service apparatus to learn more about the user's intent.

Another one of the advantages to presenting digital components only after both the information sufficiency metric thresholds have been met is that, the service apparatus can reduce the computer processing and/or network resources required to support the interaction with client device. In various situations, due to their generally higher data dimensionality and more complicated distribution criteria, selecting and presenting digital components is more computationally and communicatively expensive than selecting and presenting refinement queries. By postponing the more computationally and communicatively expensive step of digital components selection and presentation until after both the information sufficiency metric thresholds have been met, the service apparatus avoids spending any resources on the digital components in cases where they might in fact be irrelevant or undesirable to, or even negatively impact, the ongoing interaction with the client device.

Although the techniques described above use information sufficiency metrics to determine whether to provide a refinement query or digital component, some implementations can select between refinement queries and digital components as a response to a user's query. For example, the system can select from a set of responses that include refinement queries and digital components. In a particular example, the system can select the response from among these potential responses that have a highest selection value or a highest combined score. The combined score for a refinement query or digital component can be a combination of the selection value and a predicted performance metric for the refinement query or digital component, e.g., a predicted interaction rate. An interaction rate is a rate at which a user responds to a refinement query or selects (e.g., clicks on) a digital component.

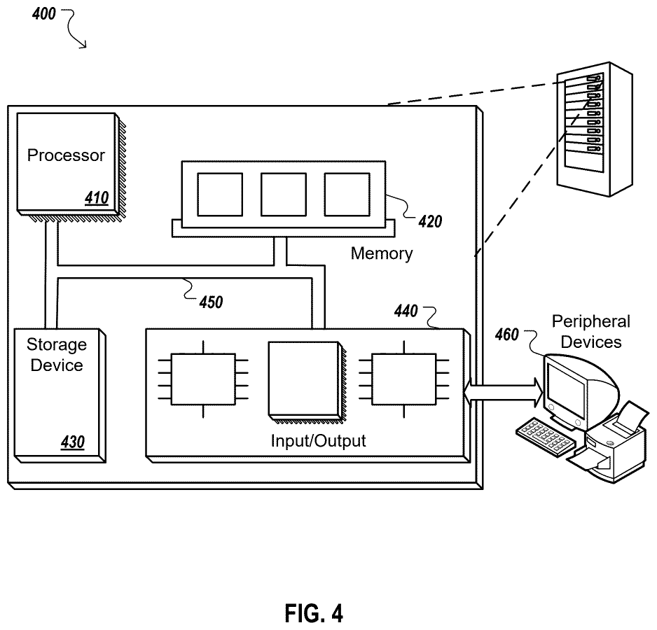

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network.

The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
receiving one or more first queries from a client device of a user;
determining that there is insufficient information based on session data comprising the one or more first queries to select a digital component to present to the user in response to the first query;
generating, based on a plurality of candidate refinement queries that are mapped to different entities, a refinement query that has a question format and prompts the user to provide additional information related to the one or more first queries;
providing the refinement query to the client device for presentation to the user as a part of a first response that is generated based on at least one of the one or more first queries;
receiving one or more second queries from the client device of the user after having provided the refinement query to the client device for presentation to the user, wherein the second query comprises a user response to the refinement query;
determining that there is sufficient information in updated session data comprising the one or more second queries and data related to at least one of the one or more first queries to select a digital component;
selecting, from a plurality of candidate digital components that are mapped to the different entities, a selected digital component mapped to a particular entity; and
sending the selected digital component to the client device for presentation to the user as a part of a second response that is generated based on the one or more second queries.

2. The method of claim 1, wherein the one or more first queries comprise a search query, and wherein the first response comprises search results generated by a search system based on the search query.

3. The method of claim 1, wherein the one or more first queries comprise a user prompt, and wherein the first response comprises a response generated by a trained language model from processing the user prompt.

4. The method of claim 1, wherein generating the refinement query based on the plurality of candidate refinement queries comprises:
performing a selection process to select one or more refinement queries from the plurality of candidate refinement queries; and
generating the refinement query based on the one or more selected refinement queries.

5. The method of claim 1, wherein generating the refinement query based on the plurality of candidate refinement queries comprises:
identifying multiple candidate refinement queries to aggregate into a final refinement query based on a semantic similarity between the candidate refinements.

6. The method of claim 5, wherein the final refinement query comprises a question that is semantically similar to questions included in the multiple identified candidate refinement queries.

7. The method of claim 6, further comprising splitting a required amount for the final refinement query between multiple entities that provided the multiple refinement queries.

8. The method of claim 1, wherein determining that there is insufficient information in the one or more first queries to select the digital component comprises:
processing the one or more first queries using the trained language model to generate a sufficiency classification output.

9. The method of claim 1, wherein generating the refinement query based on the plurality of candidate refinement queries comprises:
splitting a total amount associated with the one or more selected refinement queries among one or more entities that provided the one or more selected refinement queries.

10. One or more non-transitory computer-readable storage media storing instructions that when executed by one or more computers cause the one or more computers to perform the operations comprising:
receiving one or more first queries from a client device of a user;
determining that there is insufficient information based on session data comprising the one or more first queries to select a digital component to present to the user in response to the first query;
generating, based on a plurality of candidate refinement queries that are mapped to different entities, a refinement query that has a question format and prompts the user to provide additional information related to the one or more first queries;
providing the refinement query to the client device for presentation to the user as a part of a first response that is generated based on at least one of the one or more first queries;
receiving one or more second queries from the client device of the user after having provided the refinement query to the client device for presentation to the user, wherein the second query comprises a user response to the refinement query;
determining that there is sufficient information in updated session data comprising the one or more second queries and data related to at least one of the one or more first queries to select a digital component;
selecting, from a plurality of candidate digital components that are mapped to the different entities, a selected digital component mapped to a particular entity; and
sending the selected digital component to the client device for presentation to the user as a part of a second response that is generated based on the one or more second queries.

11. (canceled)

12. (canceled)

13. The one or more non-transitory computer-readable storage media of claim 10, wherein the one or more first queries comprise a search query, and wherein the first response comprises search results generated by a search system based on the search query.

14. The one or more non-transitory computer-readable storage media of claim 10, wherein the one or more first queries comprise a user prompt, and wherein the first response comprises a response generated by a trained language model from processing the user prompt.

15. The one or more non-transitory computer-readable storage media of claim 10, wherein generating the refinement query based on the plurality of candidate refinement queries comprises:
performing a selection process to select one or more refinement queries from the plurality of candidate refinement queries; and
generating the refinement query based on the one or more selected refinement queries.

16. The one or more non-transitory computer-readable storage media of claim 10, wherein generating the refinement query based on the plurality of candidate refinement queries comprises:
identifying multiple candidate refinement queries to aggregate into a final refinement query based on a semantic similarity between the candidate refinements.

17. The one or more non-transitory computer-readable storage media of claim 16, wherein the final refinement query comprises a question that is semantically similar to questions included in the multiple identified candidate refinement queries.

18. The one or more non-transitory computer-readable storage media of claim 17, further comprising splitting a required amount for the final refinement query between multiple entities that provided the multiple refinement queries.

19. The one or more non-transitory computer-readable storage media of claim 10, wherein determining that there is insufficient information in the one or more first queries to select the digital component comprises:
processing the one or more first queries using the trained language model to generate a sufficiency classification output.

20. The one or more non-transitory computer-readable storage media of claim 10, wherein generating the refinement query based on the plurality of candidate refinement queries comprises:
splitting a total amount associated with the one or more selected refinement queries among one or more entities that provided the one or more selected refinement queries.

21. A system comprising:
one or more computers; and
one or more storage devices storing instructions that, when executed by the one or more computers, cause the one or more computers to perform the operations comprising:
receiving one or more first queries from a client device of a user;
determining that there is insufficient information based on session data comprising the one or more first queries to select a digital component to present to the user in response to the first query;
generating, based on a plurality of candidate refinement queries that are mapped to different entities, a refinement query that has a question format and prompts the user to provide additional information related to the one or more first queries;
providing the refinement query to the client device for presentation to the user as a part of a first response that is generated based on at least one of the one or more first queries;
receiving one or more second queries from the client device of the user after having provided the refinement query to the client device for presentation to the user, wherein the second query comprises a user response to the refinement query;
determining that there is sufficient information in updated session data comprising the one or more second queries and data related to at least one of the one or more first queries to select a digital component;
selecting, from a plurality of candidate digital components that are mapped to the different entities, a selected digital component mapped to a particular entity; and
sending the selected digital component to the client device for presentation to the user as a part of a second response that is generated based on the one or more second queries.

22. The system of claim 21, wherein the one or more first queries comprise a search query, and wherein the first response comprises search results generated by a search system based on the search query.
